(19) United States
(12) Patent Application Publication
(10) Pub. No.: US 2015/0338629 A1
(43) Pub. Date: Nov. 26, 2015

(54) MICROSCOPE WITH ILLUMINATION DEVICE

(71) Applicant: LEICA MICROSYSTEMS CMS GMBH, Westzlar (DE)

(72) Inventors: Jochen SIEPER, Diez (DE); Wolfgang RENTZSCH, Braunfels (DE); Robert MAINBERGER, Braunfels (DE)

(21) Appl. No.: 14/410,132

(22) PCT Filed: Jun. 26, 2013
(86) PCT No.: PCT/EP2013/063438

§ 371 Date: Dec. 22, 2014

(30) Foreign Application Priority Data
Jun. 26, 2012 (DE) 10 2012 210 905.6

(51) Int. Cl. G02B 21/06; F21V 23/00

(52) U.S. Cl. CPC G02B 21/06; F21V 23/003

(57) ABSTRACT

A microscope includes an illumination device having a light source and two current control devices. Each of the current control devices has a target value input and a measuring resistor arrangement. The current control devices supply a through-current for the light source and control a level thereof by way of a potential difference across the measuring resistor arrangement on the basis of a signal provided at the target value input. An adjustment device is configured to set two different illumination types of the microscope. The adjustment device and the illumination device are operatively connected to each other such that setting a first illumination type switches the illumination device into a first current configuration, in which at least one current control device supplies no through-current, and setting a second illumination type switches the illumination device into a second current configuration, in which at least one control devices supplies a through-current.

### CROSS-REFERENCE TO PRIOR APPLICATIONS

This application is a U.S. National Phase application under 35 U.S.C. §371 of International Application No. PCT/EP2013/063438, filed on Jun. 26, 2013, and claims benefit to German Patent Application No. DE 10 2012 210 905.6, filed on Jun. 26, 2012. The International Application was published in German on Jan. 3, 2014 as WO 2014/001413 under PCT Article 21(2).

### FIELD

The present invention relates to a microscope equipped with an illumination device.

### BACKGROUND

In a microscope for various types of illumination (for example bright-field, dark-field, phase-contrast, fluorescence illumination), if optimum brightness is to be achieved the light intensity has to be varied within a wide dynamic range. For example, bright-field illumination only requires a little light, whilst dark-field, phase-contrast and even fluorescence illumination each require a very large amount of light.

In modern microscopes, LEDs are being used as light sources more and more frequently, since they have numerous advantages over conventional light bulbs or high-pressure lamps. LEDs usually have a longer service life, are robust, are of a small construction, develop much less heat, and can be dimmed without changing the colour.

In an LED, or generally speaking in a lighting means consisting of semiconductor material, the light intensity is controlled by way of the through-current.

### SUMMARY

In an embodiment, the present invention provides a microscope including an illumination device having a light source and at least two current control devices. Each of the at least two current control devices has a target value input and a measuring resistor arrangement. Each of the at least two current control devices are configured to supply a through-current for the light source and to control a level of the through-current by way of a potential difference across the measuring resistor arrangement on the basis of a signal provided at the target value input. An adjustment device is configured to set at least two different illumination types of the microscope. The adjustment device and the illumination device are operatively connected to each other such that setting a first illumination type of the at least two different illumination types switches the illumination device into a first current configuration, in which at least one of the at least two current control devices supplies no through-current, and setting a second illumination type of the at least two different illumination types switches the illumination device into a second current configuration, in which at least one of the at least two current control devices supplies a through-current.

### BRIEF DESCRIPTION OF THE DRAWINGS

The present invention will be described in even greater detail below based on the exemplary figures. The invention is not limited to the exemplary embodiments. Other features and advantages of various embodiments of the present invention will become apparent by reading the following detailed description with reference to the attached drawings which illustrate the following:

FIG. 1 shows an LED circuit not in accordance with the invention, having a measuring resistor arrangement having only one resistance configuration.

FIG. 2 shows a preferred embodiment of an illumination device, having two current control devices and a switching device for providing two current configurations.

FIG. 3 shows a preferred embodiment of a microscope according to the invention.

### DETAILED DESCRIPTION

The present invention recognizes that it can be problematic in particular to control the current level in such a way that the light intensity can be set as precisely as possible over the entire brightness range.

The present invention therefore provides, in an embodiment, a microscope in which the light intensity can be set as precisely as possible over the entire brightness range, in particular including for different types of illumination.

In an embodiment, the invention makes precise control of the light intensity of the light source possible by way of precise control of the through-current. To control the current level, at least two current control devices are used, which each have a measuring resistor arrangement, a potential difference across the measuring resistor arrangement being used as a control variable for the current control device. The current control device comprises a target value input and controls the current level in accordance with a signal applied thereto. A signal source may for example be a voltage divider having a potentiometer which is actuated by an operator to set the brightness, or a digital switch arrangement in which the signal is generated for example using a microcontroller.

It is possible to precisely control the light intensity over a wide brightness range in that the measuring resistor arrangements of the at least two current control devices have different electrical resistances, it being expedient for a first current control device to have a resistor arrangement having a large electrical resistance and a second current control device to have a resistor arrangement having a small electrical resistance. This makes it possible, in a particularly advantageous manner, for a small through-current to be supplied very precisely and in relatively fine increments by the first current control device and for a large through-current to be provided very precisely and in relatively rough steps by the second current control device. In this way, the potential difference can be kept sufficiently large for precise control at small through-currents (for example during bright-field illumination) through the first current control device having a large electrical resistance, and sufficiently small for a low power loss at large through-currents (for example during dark-field, phase-contrast and fluorescence illumination) through the second current control device having a small electrical resistance. At the different brightness ranges, and thus current level ranges, the control precision remains sufficiently large that both the requirements for low brightnesses, for example for bright-field illumination, and those for high brightnesses, as in phase-contrast illumination, can be covered. Moreover, adding the two currents makes it possible to adjust fine increments at large currents.

Among other things, LEDs have the property that the light intensity thereof reacts extremely rapidly to changes in current. Uncontrolled changes in the current level, which can even result from the noise of the electronic components used, in particular at very low currents, thus result in light intensity fluctuations, and are therefore undesirable. The through-current is therefore preferably provided as direct current, and this improves in particular the quality of images taken using a digital camera, since in this case even high-frequency light intensity fluctuations, which might not be perceptible to the eye, can be perceived as interferences in the image (stripes, noise etc.).

Preferably, the illumination device comprises a digital circuit having a memory device in which at least one table for voltage target-values for the individual current control devices, for example as a function of a desired brightness, is stored for specifying the target-value signals. The digital circuit may be set up to provide the same or different target values to the current control circuit. In this way, a large brightness range can be covered without switching current control devices on or off. Brightness interruptions and uncontrolled jumps in brightness can thus be prevented.

It has been found to be particularly advantageous if exactly two current control devices are provided. As a result, the constructional complexity remains low, but a large brightness region is still covered with a high level of precision.

Preferably, the electrical resistances of the measuring resistor arrangements of the first and second current regulation devices are in a ratio equal to the root of the required dynamic, for example a ratio of 1:50, 1:75 or 1:100. The dynamic refers to a quotient of the largest and the smallest current. Thus, for example, a maximum current of 10 A and a minimum current of 1 mA give a dynamic range of 1:10000. As a result of the current paths being divided into a low-current path having the larger of the measuring resistors and a high-current path having the smaller of the measuring resistors, which together form the through-current, it is possible to have both a small through-current, having a high signal-noise ratio and a high precision of light intensity, and a large through-current, having a high precision of light intensity. By adding the currents of the individual flow paths, the large through-current can also be changed and adjusted very finely, in other words at a high resolution.

Preferably, a through-current is supplied substantially merely by the first current control device in a first illumination type and by the first and the second current control device in a second illumination type. The illumination type can be switched by controlling the current strength of the second current control device to be zero or by switching the second current control device on or off, the first current control device always remaining active. In this way, brightness interruptions and current jumps when changing illumination type can be prevented. The switching on and off can be carried out by a switching device, which connects one or both target value inputs to the signal source or to the earth, i.e., to ground. It may in particular be provided that the same signal is applied to the target value inputs of all switched-on current control devices.

It is advantageous if the switch-on of the further current control devices is linked to the switching of the illumination type of the microscope (by an operator), in such a way that when the illumination type is changed a current control device is automatically switched on or off (or controlled to be zero). This may preferably be provided by way of automatic actuation of a corresponding switching device, which in particular brings about a connection of one or more target value inputs to the same signal source, or by way of a digital circuit, as described above.

Preferably, the electrical resistances of the measuring resistor arrangements of the first and second current control device are in a ratio of at least 2:1, 3:1, 4:1, 5:1, 6:1, 7:1, 8:1 or more. Preferably, the ratio of the electrical resistances is the reciprocal of the upper bounds of the desired current levels for the brightness ranges. It has been found to be particularly advantageous, if the electrical resistances of two measuring resistor arrangements are in a ratio of at least 4:1 or at most 8:1. It is particularly advantageous if the maximum through-current for a first, darker illumination type (in particular for bright-field illumination) is at most ¼ or at most ⅛ of the maximum through-current for a second, brighter illumination type (in particular for dark-field, phase-contrast and fluorescence illumination).

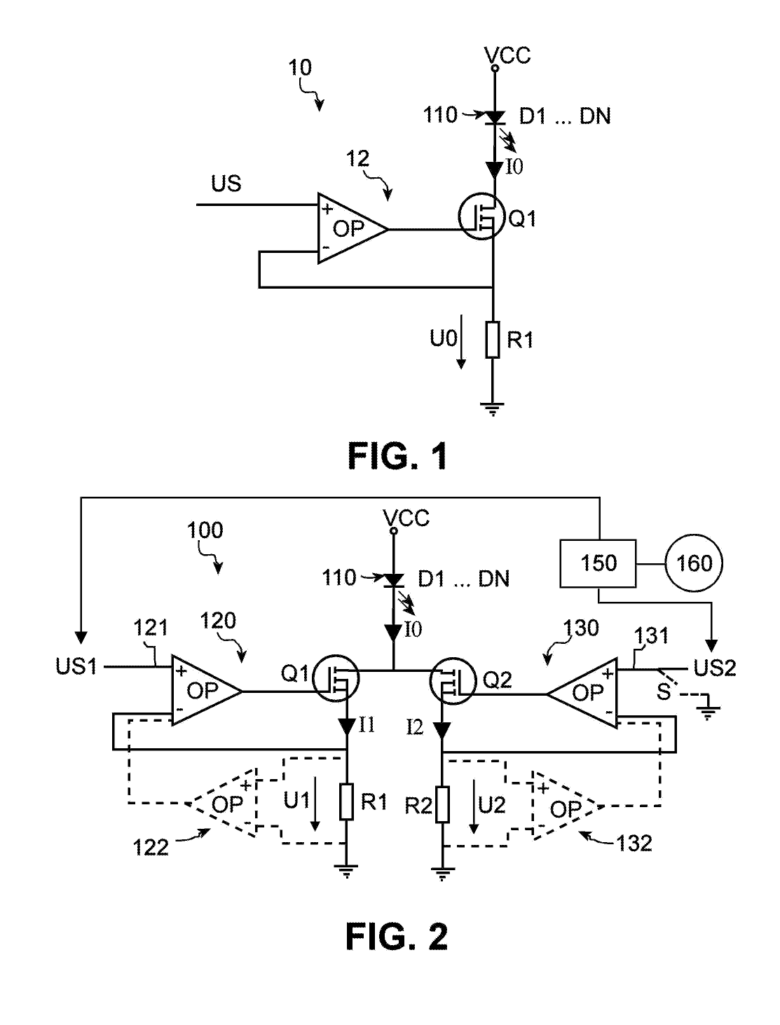

To illustrate LED current control in principle, FIG. 1 shows an LED driver circuit 10 not in accordance with the invention, which operates by the principle of a voltage-controlled current source. A through-current l₀ through a light source 100, which comprises one or more LEDs D1, . . . , DN, is controlled in accordance with a target voltage U_{S}. A voltage U₀ across a measuring resistor R1 is used as the actual voltage, and supplied together with the target voltage Uₛ to an operation amplifier OP of a current control device 12. As is known, the output signal of the operation amplifier is dependent on the voltage difference between U_{S} and U₀. The output signal is supplied to a switch element for the current setting, in this case an FET, IGBT or other transistor Q1 at the gate (or base), so as to control the current l₀ flowing through the switching element Q1 and thus through the measuring resistor R1.

In this simple LED driver circuit, there is the problem of selecting a suitable measuring resistor R1, since on the one hand the voltage across it should be large enough to obtain a noise-free signal at small currents, and on the other hand the power loss across it at large currents should still be acceptable and must not lead to damage to components.

For example, if the resistance is 1Ω, there is a voltage of 1 V at a through-current of 1 A, and 1 W power loss is brought about. As a result, however, at lower currents of for example merely 0.1 mA, there is a voltage of 0.1 mV, noise voltages of typical operation amplifiers being in the range of 0.001 mV; in other words already at one percent. However, brightness fluctuations in the percent range are already unacceptable for electronic capture and evaluation, for example by camera.

The voltage occurring at low currents can be increased by a larger measuring resistor, but in this case the power loss at larger currents increases accordingly.

To improve this situation, an illumination device 100 for a microscope is proposed, and is shown in the manner of a circuit diagram in FIG. 2. The preferred embodiment of the illumination device 100 comprises a light source 110, a first current control device 120 and a second current control device 130. The light source 110 may contain one or more LEDs D1, . . . , DN. The first current control device 120 is configured to control a through-current l₁, and the second current control device 130 is configured to control a through-current l₂. The through-currents l₁ and l₂ together form the through-current l₀=l₁+l₂ through the light source 110.

The use of LEDs in microscope illumination devices reduces the current consumption and the heat loss by comparison with coiled filaments, and so additional space for complex cooling is hardly required. An LED is advantageous by comparison with conventional light bulbs, since it has merely a small volume with a high light power and lower power uptake, and because it can be dimmed without altering the colour temperature.

The first current control device 120 comprises a measuring resistor arrangement R1 and a target value input 121, and is set up to control the level of the through-current l₁ by way of the potential difference U₁ across the measuring resistor arrangement R1 on the basis of a target voltage U_{S1} provided at the target value input. In the example shown, the current control device 120 is set up to control the level of the through-current l₀ in such a way that the potential difference U₀ across the measuring resistor arrangement R1 corresponds to the target voltage U_{S1} provided at the target value input 121. In an alternative embodiment, illustrated by dashed lines, the current control device 120 comprises a difference amplifier circuit 122, which amplifies the potential difference U₁ across the measuring resistance arrangement R1, at the target value input 121 thereof. It comprises a further operation amplifier OP which detects a potential difference across R1. As a result of the difference amplifier circuit, measurement errors caused by the wiring can be minimised.

The second current control device 130 comprises a measuring resistance arrangement R2 and a target value input 131, and is set up to control the level of the through-current l₂ by way of the potential difference U₂ across the measuring resistance arrangement R2 on the basis of a target voltage U_{S2} provided at the target value input 131. In the example shown, the current control device 130 is set up to control the level of the through-current l₂ in such a way that the potential difference U₂ across the measuring resistance arrangement R2 corresponds to the target voltage U_{S2} provided at the target value input 131.

In an alternative embodiment, illustrated by dashed lines, the current control device 130 comprises a difference amplifier circuit 132, which amplifies the potential difference U₂ at the measuring resistor arrangement R2. It comprises a further operation amplifier OP, the inverting input of which is grounded. The difference amplifier circuit 132 is thus non-inverting as a whole. By way of the difference amplifier circuit, measurement errors caused by the line guide can be minimised.

In the embodiment shown here, the target voltages U_{S1} and U_{S2} are produced by a digital circuit 150, which is for example connected to an actuation device 160, for example a rotary knob or the like, for a user, and produces the target voltages U_{S1} and U_{S2} in accordance with the set-point of the actuation device. For this purpose, the digital circuit 150 comprises for example a microprocessor having a memory device, in which for example a lookup table having voltage target values for the individual current control devices is stored.

By way of the digital circuit 150, the illumination device 100 can be brought into a first current configuration, in which 0V is provided at the target value input 131 of the second current control device 130 as the target voltage U_{S2}, and the second current control device 130 thus supplies no through-current l₂ and also does not contribute to the noise. In this context, the through-current through the light source 110 corresponds to the through-current supplied with high precision by the first current control device; l₀=l₁.

By way of the digital circuit 150, the illumination device 100 can also be brought into the second current configuration, in which more than 0V is provided at the target value input 131 of the second current control device 130 as the target voltage U_{S2}, and the second control device 130 thus supplies a through-current l₂. In this context, the through-current through the light source 110 corresponds to the sum of the through-currents supplied by the first and the second current control devices; l₀=l₁+l₂.

In the present preferred embodiment, the electrical resistors R1/R2 are preferably approximately in a ratio of 100:1, in such a way that through-currents supplied by the current control devices are approximately in a ratio of 1:100.

In an alternative embodiment, illustrated by dashed lines, a switching device S is provided at the target value input 131, and can connect the target value input 131 to the target voltage U_{S2} or to ground. The target voltage U_{S2} may be equal to the target voltage U_{S1}. The target voltages can be predetermined by a digital or an analogue circuit (for example having a potentiometer). If the target value input 131 is connected to ground, the current control device does not supply any through-current l₂.

The switching device S can also bring the illumination device 100 into the first current configuration, in which the target value input 131 of the second current control device 130 is connected to ground and the second current control device 130 thus supplies no through-current l₂. In this context, the through-current through the light source 110 corresponds to the through-current supplied by the first current control device; l₀=l₁.

The switching device S can also bring the illumination device 100 into the second current configuration, in which the target value input 131 of the second current control device 130 is connected to the signal source and the second current control device 130 thus supplies a through-current l₂. In this context, the through-current through the light source 110 corresponds to the sum of the through-currents supplied by the first and second current control devices; l₀=l₁+l₂.

In the alternative embodiment, the electrical resistors R1/R2 are preferably approximately in a ratio of 7:1, in such a way that the through-currents supplied by the current control devices are approximately in a ratio of 1:7. The through-currents through the light source are thus in a ratio of 1:8 in the circuit shown. In this case, the maximum through-current for a first, darker illumination type (in particular for bright-field illumination) contributes ⅛ of the maximum through-current for a second, brighter illumination type (in particular for dark-field, phase-contrast and fluorescence illumination). It has been found that in microscopes an illumination level ratio of bright-field illumination to dark-field or phase-contrast illumination of 1:8 is advantageous.

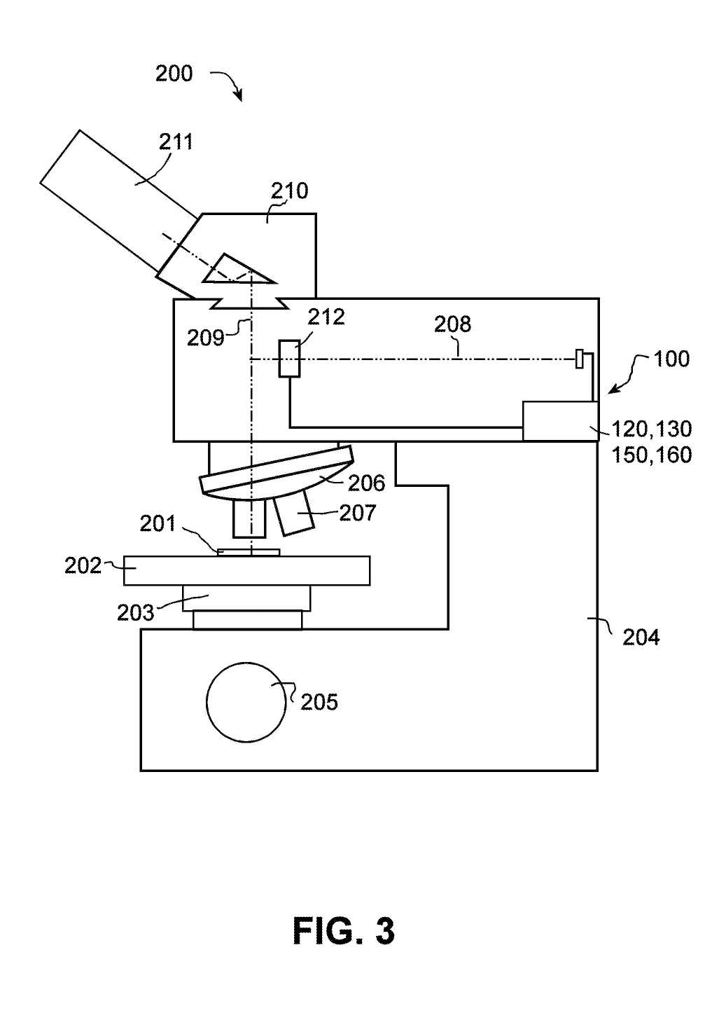

FIG. 3 is a schematic cross-sectional view of a preferred embodiment of a microscope, denoted as 200. The microscope 200 is equipped with an illumination device 100.

The microscope comprises a microscope body 204, on which a microscope stage 202 having a mounting 203 is arranged. The sample 201 is positioned on the microscope stage 202 and can be displaced vertically by means of an adjustment device configured as a rotating disc 205. Individual lenses 207 are provided on a lens rotator 206.

To illuminate a sample 201, the illumination device 100 is provided at one end of an illumination beam path 208. In an observation beam path 209, the illuminating light reflected by the sample 201 reaches an eyepiece 211 via a lens tube 210. The optical axes of the beam paths are illustrated by dashed lines. Optical elements such as beam splitters, lenses, apertures, etc., which are not relevant to the present invention and are therefore not identified in greater detail, may be arranged in the beam paths.

An adjustment device 212 is arranged in the illumination beam path, and in one embodiment is in an operative connection to the illumination device 100, in particular the switching device S or the digital circuit 150. The adjustment device 212 is configured to change the illumination type of the microscope; in particular, the adjustment device 212 makes it possible to set a bright-field and a dark-field illumination, and more preferably also a phase-contrast and/or a fluorescence illumination. The adjustment device 212 may comprise a slider which is displaceable in a guide, sensors being provided which detect the position of the slider and pass it on to a control device, in particular within the illumination device 100. The control device controls the switching device S or the digital circuit 150 as a function of the detected position, the switching device S preferably connecting the target value input to ground during bright-field illumination and connecting the target value input to the signal source during the other aforementioned illumination types. Alternatively or in addition, there is an actuation element 160 which is connected to the digital circuit 150.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

1. A microscope comprising:
an illumination device having a light source and at least two current control devices, each of the at least two current control devices having a target value input and a measuring resistor arrangement and being configured to supply a through-current for the light source and to control a level of the through-current by way of a potential difference across the measuring resistor arrangement on the basis of a signal provided at the target value input; and
an adjustment device configured to set at least two different illumination types of the microscope, the adjustment device and the illumination device being operatively connected to each other such that setting a first illumination type of the at least two different illumination types switches the illumination device into a first current configuration, in which at least one of the at least two current control devices supplies no through-current, and setting a second illumination type of the at least two different illumination types switches the illumination device into a second current configuration, in which at least one of the at least two current control devices supplies a through-current.

2. The microscope according to claim 1, wherein the measuring resistor arrangement of a first current control device of the at least two current control devices has a different electrical resistance from the measuring resistor arrangement of a second current control device of the at least two current control devices.

3. The microscope according to claim 2, wherein a value of the electrical resistance of the measuring resistor arrangements of the first current control device is at least twice, three times, four times, five times, six times, seven times or eight times a value of the electrical resistance of the measuring resistor arrangement of the second current control device.

4. The microscope according to claim 2, wherein a value of the electrical resistance of the measuring resistor arrangement of the first current control device is at least fifty times, seventy-five times or one hundred times a value of the electrical resistance of the measuring resistor arrangement of the second current control device.

5. The microscope according to claim 1, wherein the at least two current control devices are configured to supply a direct current as the through-current.

6. The microscope according to claim 1, wherein the light source comprises at least one LED.

7. The microscope according to claim 1, further comprising a circuit which is configured to operate the illumination device in a first current configuration, in which at least one of the at least two current control devices supplies no through-current, and to operate the illumination device in a second current configuration, in which at least one of the at least two current control devices supplies a through-current.

8. The microscope according to claim 7, wherein the circuit includes a switching device connected to the target value input of at least one of the at least two current control devices, to ground and to a signal source, wherein the switching device is configured to connect the target value input to ground in the first current configuration and to connect the target value to the signal source in the second current configuration.

9. The microscope according to claim 1, wherein the at least two current control devices are connected in parallel, in such a way that the through-currents supplied by the at least two current control devices are combined into a total through-current through the light source.

10. The microscope according to claim 1, wherein at least one of the at least two current control devices is configured to control a level of the through-current in such a way that the potential difference across the measuring resistor arrangement corresponds to a target voltage at the target value input.

11. The microscope according to claim 1, wherein at least one of the at least two current control devices comprises a difference amplifier circuit at which the potential difference across the measuring resistor arrangement is present.

12. The microscope according to claim 1, wherein one of the at least two different illumination types is a bright-field illumination and another of the at least two different illumination types is a dark-field, phase-contrast or fluorescence illumination.
